(19) United States
(12) Patent Application Publication
(10) Pub. No.: US 2026/0105554 A1
(43) Pub. Date: Apr. 16, 2026

(54) SYSTEM AND METHOD FOR PROVIDING MONITORING INFORMATION ON USE OF COPYRIGHTED WORKS FOR COPYRIGHT HOLDERS

(71) Applicant: LSWARE INC., Seoul (KR)

(72) Inventors: Min Soo KIM, Gyeonggi-do (KR); Dong Myung SHIN, Seoul (KR); Yong Joon JOE, Seoul (KR); Won Bin KIM, Gyeonggi-do (KR)

(21) Appl. No.: 19/351,562

(22) Filed: Oct. 7, 2025

(30) Foreign Application Priority Data
Oct. 10, 2024 (KR) 10-2024-0137624

(51) Int. Cl. G06Q 50/18

(52) U.S. Cl. CPC G06Q 50/184

(57) ABSTRACT

Disclosed is a system for providing monitoring information on use of copyrighted works for copyright holders, the system including: a contract management server configured to execute an electronic contract related to use of first copyrighted works between first copyright holders of the first copyrighted works and second copyright holders of second copyrighted works created using the first copyrighted works; and a copyrighted work supply server configured to provide an online supply service for the first copyrighted works or the second copyrighted works, generate use status information of the second copyrighted works, indicating a use status of each of at least one second copyrighted works created using the first copyrighted works, and provide the use status information to the contract management server upon a request from the contract management server.

### CROSS-REFERENCE TO RELATED APPLICATION

This application claims priority from Korean Patent Application No. 10-2024-0137624 filed on October 10, 2024 in the Korean Intellectual Property Office, the contents of which in its entirety are herein incorporated by reference.

### FIELD

The present disclosure relates to a technology for providing information on copyrighted works, and more particularly, to a system and method for providing information on the use of second copyrighted works created using first copyrighted works.

### BACKGROUND

Although a creator is able to produce an entire copyrighted work from beginning to end, it is also possible to create a second copyrighted work by using a first copyrighted work created by another creator. In particular, works such as movies and games are generally not created by a single creator alone but are usually created by combining first copyrighted works produced by numerous creators into one new second copyrighted work.

The first copyrighted works created in this manner are used under various licensing agreements, and the second copyrighted work must comply with all the licensing agreements of the first copyrighted works used therein. Furthermore, for various reasons, such as the need in modern times to exclude works by creators with specific ideologies, there is a need for a method for easily determining which first copyrighted works have been used in a second copyrighted work and under what conditions.

### SUMMARY

The present disclosure provides a system and method for providing monitoring information on the use of copyrighted works for copyright holders, which indicates whether second copyrighted works created using first copyrighted works are being properly used in compliance with an electronic contract concluded with copyright holders of the first copyrighted works.

Other objects and advantages of the present disclosure will be apparent from the following description, and will be more clearly understood by embodiments of the present disclosure. In addition, it will be readily apparent that the objects and advantages of the present disclosure may be realized by the means and combinations thereof set forth in the claims.

In one aspect, a system for providing monitoring information on use of copyrighted works for copyright holders includes: a contract management server configured to execute an electronic contract related to use of first copyrighted works between first copyright holders of the first copyrighted works and second copyright holders of second copyrighted works created using the first copyrighted works; and a copyrighted work supply server configured to provide an online supply service for the first copyrighted works or the second copyrighted works, generate use status information of the second copyrighted works, indicating a use status of each of at least one second copyrighted works created using the first copyrighted works, and provide the use status information to the contract management server upon a request from the contract management server. The contract management server includes: a contract management database configured to store contract condition information including a supply channel item related to a supply channel for the second copyrighted works, a moral rights permission item related to the first copyrighted works in connection with the second copyrighted works, a reuse permission item indicating whether creation of third copyrighted works using the second copyrighted works is permitted, and a fee item related to a method for calculating fees incurred from the supply of the second copyrighted works; a contract conclusion unit configured to execute the electronic contract between the first copyright holders and the second copyright holders using the contract condition information and generate contract conclusion information according to the electronic contract; and a monitoring information generation unit configured to compare the use status information received from the copyrighted work supply server with supply channel information, moral rights permission information, reuse permission information, and fee information included in the contract conclusion information; generate, based on a result of the comparison, contract monitoring information indicating whether the second copyrighted works are being used in compliance with the electronic contract; and transmit the contract monitoring information to a user terminal.

The use status information may include actual supply channel information, actual moral rights permission information, actual reuse permission information, and actual fee information for the second copyrighted works.

The contract conclusion unit may be configured, after setting the supply channel item, to set a moral rights permission item corresponding to the supply channel item, subsequently to set a reuse permission item corresponding to the moral rights permission item, and then to set a fee item, thereby generating the contract conclusion information including contractual supply channel information, contractual moral rights permission information, contractual reuse permission information, and contractual fee information according to the electronic contract.

The contract management server may further include a contract management interface unit configured to transmit the contract monitoring information to the user terminal and support displaying the contract monitoring information on the user terminal.

The copyrighted work supply server may include: a copyrighted work database configured to store copyrighted work matching information and use status information for each of the second copyrighted works created using the first copyrighted works; a list information extraction unit configured to extract second copyrighted work list information for the second copyrighted works created using the first copyrighted works from the copyrighted work matching information in response to a request from the contract management server; and a use status information extraction unit configured to extract the use status information corresponding to the second copyrighted work list information from the copyrighted work database.

The copyrighted work database may further be configured to store, as the copyrighted work matching information, matching information related to a list of the second copyrighted works created using the first copyrighted works and a list of the first copyrighted works used in the creation of the second copyrighted works.

In another aspect, a method for providing monitoring information on use of copyrighted works for copyright holders includes: executing, by a contract management server, an electronic contract related to use of first copyrighted works between first copyright holders of the first copyrighted works and second copyright holders of second copyrighted works created using the first copyrighted works; providing, by a copyrighted work supply server, use status information of the second copyrighted works indicating a use status of each of the second copyrighted works created using the first copyrighted works, and providing the use status information to the contract management server upon a request from the contract management server; storing, by the contract management server, contract condition information comprising a supply channel item related to a supply channel for the second copyrighted works, a moral rights permission item related to the first copyrighted works in connection with the second copyrighted works, a reuse permission item indicating whether creation of third copyrighted works using the second copyrighted works is permitted, and a fee item related to a method for calculating fees incurred from the supply of the second copyrighted works; comparing, by the contract management server, the use status information received from the copyrighted work supply server with supply channel information, moral rights permission information, reuse permission information, and fee information included in contract conclusion information generated according to the electronic contract; generating, by the contract management server based on a result of the comparing, contract monitoring information indicating whether the second copyrighted works are being used in compliance with the electronic contract; and transmitting, by the contract management server, the generated contract monitoring information to a user terminal.

The use status information may include actual supply channel information, actual moral rights permission information, actual reuse permission information, and actual fee information for the second copyrighted works.

The executing of the electronic contract may include, after setting the supply channel item, setting the moral rights permission item corresponding to the supply channel item, subsequently setting the reuse permission item corresponding to the moral rights permission item, and then setting the fee item, thereby generating the contract conclusion information including contractual supply channel information, contractual moral rights permission information, contractual reuse permission information, and contractual fee information according to the electronic contract.

The providing of the use status information to the contract management server may include storing, by the copyrighted work supply server, copyrighted work matching information and use status information for each of the second copyrighted works created using the first copyrighted works; extracting, from the copyrighted work matching information, second copyrighted work list information for the second copyrighted works created using the first copyrighted works, in response to a request for the use status information related to the first copyrighted works from the contract management server; and providing the use status information corresponding to the second copyrighted work list information to the contract management server.

The copyrighted work matching information may include matching information related to a list of the second copyrighted works created using the first copyrighted works and a list of the first copyrighted works used in the creation of the second copyrighted works.

The method may further include transmitting the contract monitoring information to the user terminal and supporting displaying the contract monitoring information on the user terminal.

### BRIEF DESCRIPTION OF THE DRAWINGS

The following drawings attached to this specification illustrate preferred embodiments of the present disclosure and, together with specific details for carrying out the present disclosure, serve to facilitate understanding of the technical concept of the present disclosure. Therefore, the present disclosure should not be construed as being limited to the matters described in such drawings.

FIG. 1 is a block diagram illustrating a system for providing monitoring information on the use of copyrighted works for copyright holders according to one embodiment of the present disclosure.

FIG. 2 is a block diagram illustrating a contract management server shown in FIG. 1.

FIG. 3 is a diagram illustrating the process of generating contract condition information by a contract conclusion unit shown in FIG. 2.

FIG. 4 is a reference diagram illustrating the process of generating contract conclusion information by the contract conclusion unit shown in FIG. 2.

FIG. 5 is a block diagram illustrating a copyrighted work supply server shown in FIG. 1.

FIG. 6 is a flowchart illustrating a method for providing monitoring information on the use of copyrighted works for copyright holders according to one embodiment of the present disclosure.

FIG. 7 is a timing diagram illustrating an overall operation process of a system and method for providing monitoring information on the use of copyrighted works for copyright holders.

### DETAILED DESCRIPTION

Hereinafter, embodiments of the present disclosure will be described in detail with reference to the accompanying drawings.

The embodiments of the present disclosure are provided to fully describe the invention to those skilled in the art, and the embodiments described below may be implemented in various forms, and the scope of the present disclosure is not limited thereto. Rather, these embodiments are provided so that this disclosure will be thorough and complete and will fully convey the concept of the invention to those skilled in the art.

The terminology used herein is for the purpose of describing particular embodiments and is not intended to limit the present disclosure. As used herein, the singular form may include the plural form unless the context clearly indicates otherwise. As used herein, the term "and/or" includes any and all combinations of one or more of the listed items. In the present specification, an original copyrighted work is defined as a “first copyrighted work,” and a creator thereof is defined as a “first copyright holder.” A derivative work created using the first copyrighted work is defined as a “second copyrighted work,” and a derivative work created using the second copyrighted work is defined as a “third copyrighted work.” In this sequential manner, derivative works created using preceding works are defined as a “fourth copyrighted work,” … an “n-th copyrighted work,” and copyright holders of the respective works are defined in the same manner.

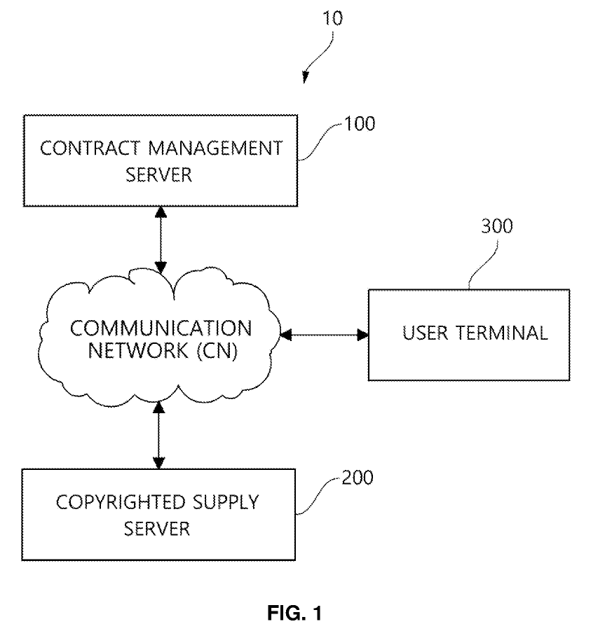

FIG. 1 is a block diagram illustrating a system for providing monitoring information on the use of copyrighted works for copyright holders (hereinafter referred to as the “monitoring information providing system”) according to one embodiment of the present disclosure.

Referring to FIG. 1, a monitoring information providing system 10 includes a contract management server 100 and a copyrighted work supply server 200. In addition, the monitoring information providing system 10 may include a user terminal 300 and a communication network (CN) for network connection between the contract management server 100 and the copyrighted work supply server 200.

The contract management server 100 executes an electronic contract related to the use of first copyrighted works between first copyright holders of the first copyrighted works and second copyright holders of second copyrighted works created using the first copyrighted works, and stores contract conclusion information generated according to the electronic contract.

The electronic contract refers to an electronic contract related to conditions, methods, and scope of use of the first copyrighted works for creating the second copyrighted works.

The electronic contract may be an electronic contract for creating the second copyrighted works using the first copyrighted works, or an electronic contract for creating a third copyrighted work using the second copyrighted works. In this way, the electronic contract includes an electronic contract related to the use of an (n–1)-th copyrighted work between an (n–1)-th copyright holder of the (n–1)-th copyrighted work and an n-th copyright holder of an n-th copyrighted work created using the (n–1)-th copyrighted work.

The contract management server 100 generates contract monitoring information indicating whether the second copyrighted works created using the first copyrighted works are being used in compliance with the electronic contract.

The copyrighted work supply server 200 provides a copyright supply service for any first or second copyrighted works. The copyrighted work supply service may include services provided through content distribution platforms such as YouTube, Spotify, and Netflix.

In addition, the copyrighted work supply server 200 generates use status information of the second copyrighted works, and provides the use status information to the contract management server 100 upon a request from the contract management server 100.

The user terminal 300 may be used by each first copyright holder or each second copyright holder. The user terminal 300 may include a desktop PC, a mobile device, and the like.

The user terminal 300 is connected to the contract management server 100 or the copyrighted work supply server 200 through the CN. The CN may be a wired communication network, including an Ethernet communication network or a serial (USB) communication network. The communication network may also be a wireless communication network, including wireless Internet (WiFi) or mobile communication networks for services such as 2G to 5G.

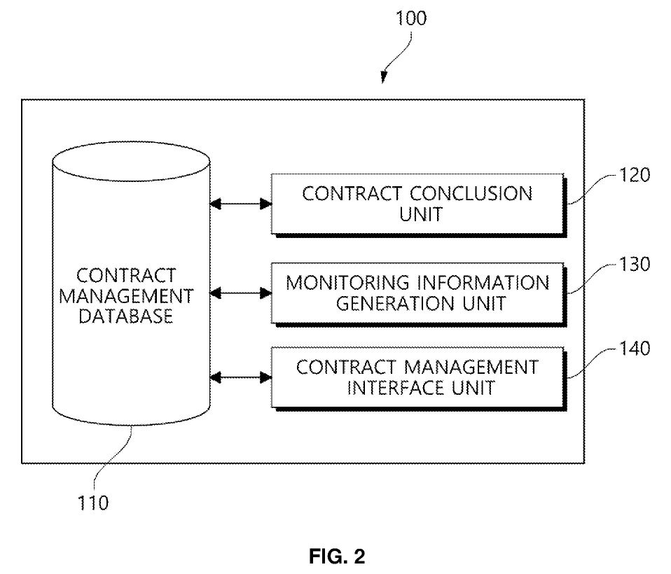

FIG. 2 is a block diagram illustrating the contract management server 100 shown in FIG. 1.

Referring to FIG. 2, the contract management server 100 includes a contract management database 110, a contract conclusion unit 120, a monitoring information generation unit 130, and a contract management interface unit 140.

The contract management database 110 stores contract condition information, contract conclusion information, and contract monitoring information for electronic copyright contract.

The contract condition information includes items specifying conditions for the use of copyrighted works, including a supply channel item related to the supply of the second copyrighted works, a moral rights permission item related to the first copyrighted works in connection with the second copyrighted works, a reuse permission item indicating whether creation of third copyrighted works using the second copyrighted works is permitted, and a fee item related to a method for calculating fees incurred from the supply of the second copyrighted works.

The supply channel item may include, for example, social networking services (SNS), video platforms (YouTube, Afreeca TV, etc.), CD/DVD/USB, newspapers, websites, TV, and movies. In addition, the moral rights permission item includes a right-of-integrity permission item (concerning the nature of the work, such as sexuality, violence, religious nature, and political nature) and a right-of-attribution permission item (indication of the name of the first copyright holder, indication of credits, etc.).

The contract management database 110 stores contract condition program information, including electronic forms and electronic setting methods, which are configured to enable a user (a first copyright holder, a second copyright holder, or the like) to select and set items such as the supply channel item, the moral rights permission item, the reuse permission item, and the fee item through a user terminal 300. The contract condition program information may be provided to the user terminal 300 of the first copyright holder and the second copyright holder.

The contract conclusion unit 120 executes the contract condition program information, provides an electronic form and electronic setting method for configuring contract conditions to the user terminal 300 of the first copyright holder, and generates contract condition information corresponding to items selected through the user terminal 300 of the first copyright holder.

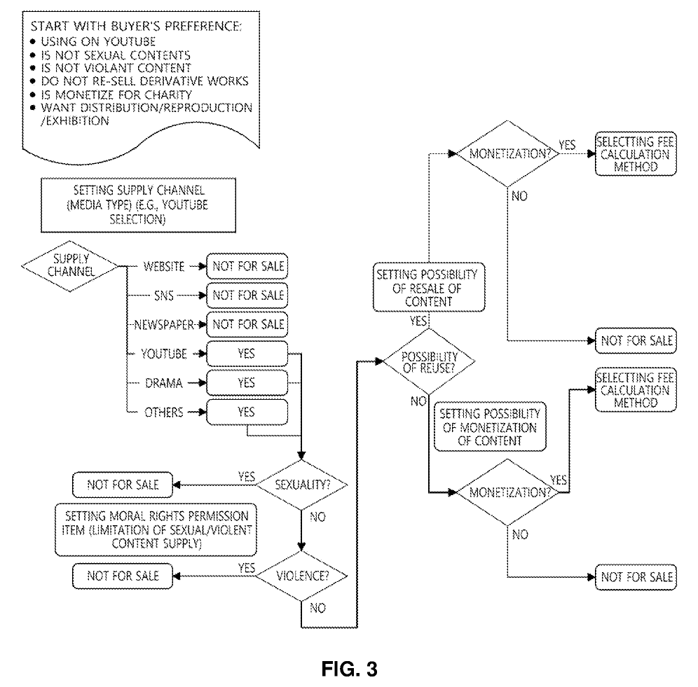

FIG. 3 is a reference diagram illustrating the process of generating contract condition information by the contract conclusion unit 120 shown in FIG. 2.

Referring to FIG. 3, the process is illustrated in which a first copyright holder checks contract condition information through the user terminal of the first copyright holder and sets usage conditions for a first copyrighted work of the first copyright holder. Accordingly, the first copyright holder may set contract condition information for a second copyrighted work created using the first copyrighted work, including a supply channel item (e.g., a platform such as YouTube and an operation channel of a second copyright holder (user) within the platform), a moral rights permission item (e.g., whether sexuality, violence, etc. are permitted), a reuse permission item for the second copyrighted work (whether reuse is permitted), and a fee item (whether monetization is permitted and the fee calculation method according to individual rights under copyright).

Upon a request from the first copyright holder, the contract conclusion unit 120 may create and register a contract condition program to permit the use of the first copyrighted work based on a supply channel item, a moral rights permission item, whether monetization is permitted, whether reuse of the first copyrighted work is permitted, and the like. This program may be applied to one work or to multiple works.

Thereafter, the contract conclusion unit 120 executes an electronic contract for copyrighted works between the first copyright holder and the second copyright holder using the contract condition information stored in the contract management database 110, and generates contract conclusion information according to the electronic contract and stores the contract conclusion information in the contract management database 110. The contract conclusion information refers to information regarding the electronic contract executed based on the contract condition information.

To this end, as shown in FIG. 3, the contract conclusion unit 120 provides the contract condition information to a user terminal 300 of the second copyright holder, and generates contract conclusion information corresponding to electronic contract items set according to the contract condition information through the user terminal 300 of the second copyright holder.

The contract conclusion unit 120, after setting a supply channel item for the second copyrighted work, sets a moral rights permission item corresponding to the supply channel item, subsequently sets a reuse permission item corresponding to the moral rights permission item, and then sets a fee item. The contract conclusion unit 120 thereby generates contract conclusion information including contractual supply channel information, contractual moral rights permission information, contractual reuse permission information, and contractual fee information according to the electronic contract.

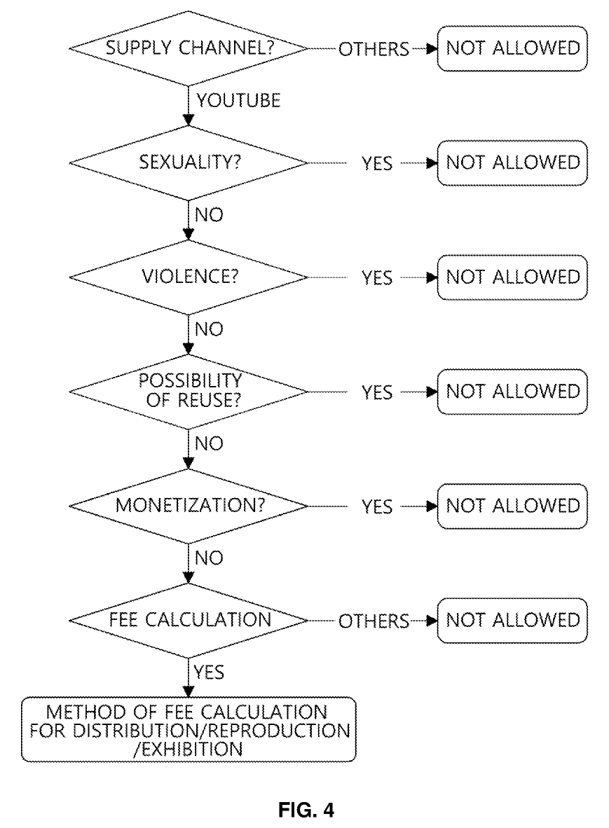

FIG. 4 is a reference diagram illustrating the process of generating contract conclusion information by the contract conclusion unit 120 shown in FIG. 2.

Referring to FIG. 4, the contract conclusion information includes information corresponding to electronic contract items sequentially selected or set by a second copyright holder (i.e., the person who intends to create or has created a second copyrighted work using a first copyrighted work) according to the contract condition information. That is, the contract conclusion information includes contractual supply channel information, contractual moral rights permission information, contractual reuse permission information, and contractual fee information.

For example, the contract conclusion unit 120 sets contractual supply channel information for the second copyrighted work based on one or more items selected by the second copyright holder, such as a website, an SNS, a newspaper outlet, a YouTube channel, or a drama. According to the set contractual supply channel information, the contract conclusion unit 120 sets contractual moral rights permission information based on one or more items selected by the second copyright holder, including a permission item for the right of integrity (e.g., sexuality, violence, religion, politics) or a permission item for the right of attribution (e.g., indication of the name of the first copyright holder, indication of credits). Then, according to the set contractual moral rights permission information, the contract conclusion unit 120 sets contractual reuse permission information of the second copyrighted work (e.g., whether creation of a third copyrighted work using the second copyrighted work is permitted). After setting the contractual reuse permission information, the contract conclusion unit 120 sets contractual fee information (e.g., fee settlement date, settlement method, etc.) according to monetization of the second copyrighted work, and generates the contract conclusion information through these settings.

From the perspective of the second copyright holder, the second copyright holder sequentially inputs necessary information as contract conclusion information, such as the intended use (supply channel information) and method of use (e.g., a political propaganda, a provocative movie, an educational SNS advertisement, and the like) of the second copyrighted work to be created, through the contract management server 100. This information is as shown in FIG. 4. When this information is input, the contract conclusion unit 120 generates contract conclusion information corresponding to the input information for each first copyrighted work.

The information input to the contract conclusion unit 120 is supply channel information, which corresponds to one or more channels input by the second copyright holder. If a channel not permitted by the first copyright holder of the first copyrighted work is selected, a contract is not concluded and contract conclusion information is not generated. The user may select two or more supply channels (e.g., YouTube and TV). Thereafter, depending on the selection of a supply channel, the second copyright holder responds to an inquiry regarding the moral rights permission items designated by the first copyright holder. For example, in FIG. 4, if the first copyright holder requires permission for the right of integrity among the moral rights items (particularly, permission to sexuality and violence), the creation of the second copyrighted work including sexuality and violence may not be permitted.

Thereafter, whether the reuse of the first copyrighted work (i.e., the right to create a derivative copyrighted work using the first copyrighted work) is permitted is determined. In FIG. 4, if the reuse of the first copyrighted work is permitted, contract conclusion information requiring higher royalties may be generated.

Thereafter, whether monetization of the second copyrighted work is permitted is determined, and if so, contract conclusion information requiring higher royalties may be generated.

Thereafter, the monetization purpose and method are identified (e.g., Proprietary: direct monetization, Charity: monetization for donations, and Advertise: monetization based on expected advertising revenue).

Finally, according to a contract such as that shown in FIG. 4, which is generated based on the conditions set by the copyright holder of the first copyrighted work, the creator of the second copyrighted work concludes a license agreement based on contract conclusion information finally generated by FIG. 4.

As described above, depending on the supply channel information, moral rights permission information, reuse permission information, and fee information sequentially selected by the second copyright holder, the contract conclusion unit 120 may generate various types of contract conclusion information, which may include conditions such as fee information (e.g., lump-sum payment, running guarantee, composite method, and penalty for violation), permitted copyright types (e.g., transmission rights, reproduction rights, and exhibition rights), genre of the second copyrighted work, and the number of uses.

The monitoring information generation unit 130 generates contract monitoring information upon a request from the user terminal 300 of the first copyright holder. The contract monitoring information refers to analysis information indicating whether a second copyrighted work created using the first copyrighted work is being used in compliance with the electronic contract.

The monitoring information generation unit 130 compares the use status information received from the copyrighted work supply server 200 with the contract conclusion information, and generate contract monitoring information based on a result of the comparison. The generated contract monitoring information is then transmitted to the user terminal 300.

The first copyright holder may want to check whether a second copyrighted work using the first copyrighted work is being used in compliance with the previously concluded agreement, for example, how the second copyrighted work is being serviced or distributed through a copyrighted work supply channel. Accordingly, the first copyright holder connects the user terminal 300 to the contract management server 100 and requests contract monitoring information, which indicates the current use status of the second copyrighted work using the first copyrighted work. The contract management server 100 may provide a user interface (UI) to the user terminal 300 so that the first copyright holder can request contract monitoring information through the user terminal 300. The user interface may be provided through the contract management interface unit 140 which will be described later.

Accordingly, upon a request for contract monitoring information from the user terminal 300, the monitoring information generation unit 130 compares the use status information of the second copyrighted work with the supply channel information, copyright moral rights permission information, copyright reuse permission information, and fee information included in the contract conclusion information, and generates, based on a result of the comparison, contract monitoring information, which is analysis information on whether the supply service for the second copyrighted work is being used in compliance with an electronic contract for copyrighted works.

The use status information includes actual supply channel information, actual moral rights permission information, actual reuse permission information, and actual fee information for the second copyrighted work. The actual supply channel information refers to information on a channel through which the second copyrighted work is actually supplied. The actual moral rights permission information refers to information on the nature of the second copyrighted work related to items of permission for the right of integrity (e.g., sexuality, violence, religion, politics, and the like) and the right of attribution (e.g., indication of the name of the first copyright holder, indication of credits, and the like). The actual reuse permission information refers to whether a third copyrighted work has been actually created using the second copyrighted work. The actual fee information refers to actual fees incurred according to the supply of the second copyrighted work.

This use status information does not exist in the contract management server 100 and must be provided from the copyrighted work supply server 200. To this end, the monitoring information generation unit 130 requests use status information from the copyrighted work supply server 200. The monitoring information generation unit 130 may transmit identification information of the first copyrighted work to the copyrighted work supply server 200 together with a request signal for use status information. Accordingly, the copyrighted work supply server 200 extracts second copyrighted work list information and the use status information corresponding thereto, and transmits the second copyrighted work list information and the corresponding use status information to the contract management server 100.

Upon receiving the second copyrighted work list information and the corresponding use status information from the copyrighted work supply server 200, the monitoring information generation unit 130 extracts contract conclusion information for the second copyrighted works included in the received second copyrighted work list information from the contract database 110.

Thereafter, the monitoring information generation unit 130 may compare the contract conclusion information for the second copyrighted works(e.g., contractual supply channel information, contractual moral rights permission information, contractual reuse permission information, and contractual fee information) with the corresponding use status information (e.g., actual supply channel information, actual moral rights permission information, actual reuse permission information, and actual fee information), and generate, based on a result of the comparison, contract monitoring information indicating whether the second copyrighted works created using the first copyrighted works are being used in compliance with an electronic contract for copyrighted works.

The monitoring information generation unit 130 may generate, as contract monitoring information, use status confirmation information indicating whether the second copyrighted works are being used in compliance with the contract conditions, together with the use status information of the second copyrighted works.

For example, when the contract conclusion information and the corresponding use status information for the second copyrighted works match, the monitoring information generation unit 130 may generate, as contract monitoring information, use status confirmation information indicating that the corresponding second copyrighted work is being used in compliance with the contract conditions. In addition, when the contract conclusion information and the corresponding use status information for the second copyrighted works do not match, the monitoring information generation unit 130 may generate, as contract monitoring information, use status confirmation information indicating that the corresponding second copyrighted work is being used abnormally (e.g., a case where copyright moral rights permission information does not match or where supply channel information does not match).

The contract management interface unit 140 supports displaying contract condition information, contract conclusion information, or contract monitoring information on the user terminal 300 of the first copyright holder accessing the contract management server 100. For this purpose, the contract management interface unit 140 is connected to the user terminal 300 through a communication network (CN).

The contract management interface unit 140 provides a user interface (UI) to the user terminal 300 for entering search conditions for the contract condition information, the contract conclusion information, or the contract monitoring information.

When a request to conclude an electronic contract is received from the user terminal 300, the contract management interface unit 140 extracts contract condition information for the electronic contract from the contract database 110 and supports displaying the extracted information on the user terminal 300.

Thereafter, as the contract condition information is displayed on the user terminal 300, each first copyright holder or second copyright holder (the person using a corresponding first copyrighted work) may set conditions of the use for the corresponding first copyrighted work or second copyrighted work according to the displayed contract condition information. Accordingly, the contract management interface unit 140 provides the setting information for the electronic contract, which is supplied from the user terminal 300, to the contract conclusion unit 120, to execute the electronic contract.

In addition, the contract management interface unit 140 may allow additional conditions not yet reflected to be set in addition to the conditions input in advance, and may support displaying contract conclusion information corresponding to the conclusion of the electronic contract on the user terminal 300. Accordingly, the contract conclusion information is displayed on the user terminal 300.

In addition, the contract management interface unit 140 may provide information for setting a fee calculation condition and may control the display of a simulation result on the user terminal 300 based on the set fee calculation condition. At this point, the contract management interface unit 140 may allow adjustment of only a variable used in the fee calculation condition, display a change in the settlement amount through the adjustment of the variable, and control the display of a corresponding change graph.

In addition, the contract management interface unit 140 may support displaying, on the display screen of the user terminal 300, contract monitoring information for the second copyrighted works that use the first copyrighted works. Accordingly, the contract monitoring information is displayed on the user terminal 300 with the support of the contract management interface unit 140.

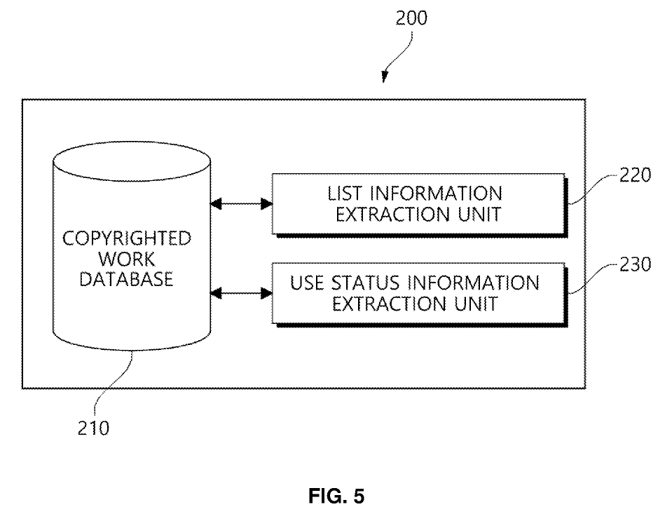

FIG. 5 is a block diagram illustrating the copyrighted work supply server 200 shown in FIG. 1.

Referring to FIG. 5, the copyrighted work supply server 200 includes a copyrighted work database 210, a list information extraction unit 220, and a use status information extraction unit 230.

The copyrighted work database 210 stores copyrighted work matching information, use status information for second copyrighted works, and the like.

The copyrighted work matching information includes identification information of first copyrighted works and second copyrighted works, and also includes matching information related to a list of second copyrighted works created using first copyrighted works and a list of the first copyrighted works used in the creation of the second copyrighted works.

As mentioned above, the use status information includes actual supply channel information, actual moral rights permission information, actual reuse permission information, and actual fee information for the second copyrighted works.

When a request for use status information of the second copyrighted works created using the first copyrighted works is received from the contract management server 100, the list information extraction unit 220 extracts second copyrighted work list information, which indicates the second copyrighted works created using the first copyrighted works, from the copyrighted work matching information.

When requesting the use status information from the copyrighted work supply server 200, the contract management server 100 may also transmit identification information of the first copyrighted works. Accordingly, the list information extraction unit 220 may extract the second copyrighted work list information corresponding to the identification information of the first copyrighted works from the copyrighted work matching information of the copyrighted work database 210.

The use status information extraction unit 230 extracts use status information of the second copyrighted works from the copyrighted work database 210.

Upon receiving the second copyrighted work list information from the list information extraction unit 220, the use status information extraction unit 230 extracts use status information of the second copyrighted works corresponding to the second copyrighted work list information from the copyrighted work database 210. For example, the use status information extraction unit 230 may extract actual supply channel information, actual moral rights permission information, actual reuse permission information, and actual fee information for the second copyrighted works from the copyrighted work database 210.

Thereafter, the use status information extraction unit 230 transmits the second copyrighted work list information and the corresponding use status information to the contract management server 100. Accordingly, as described above, the contract management server 100 may compare the use status information of the second copyrighted works created using the first copyrighted works with the contract conclusion information of the first copyrighted works and the second copyrighted works, and generate contract monitoring information based on a result of the comparison.

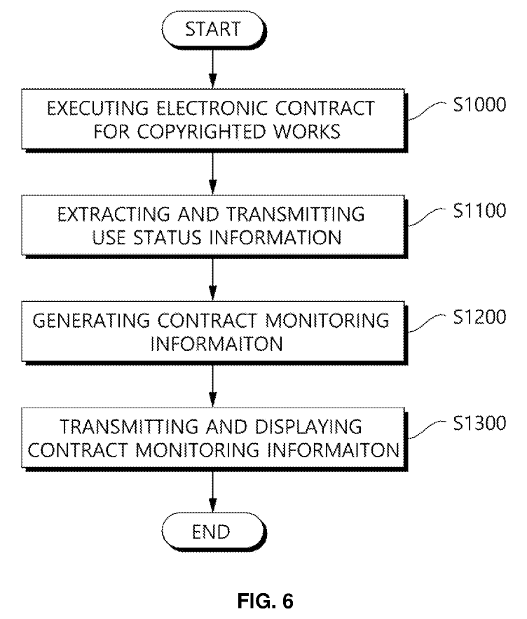

FIG. 6 is a flowchart illustrating a method for providing monitoring information on the use of copyrighted works for copyright holders according to one embodiment of the present disclosure.

First, the contract management server executes an electronic contract related to the use of first copyrighted works between first copyright holders of the first copyrighted works and second copyright holders of second copyrighted works created using the first copyrighted works, and stores contract conclusion information generated according to the electronic contract in operation S1000.

The contract management server stores contract condition information for the electronic contract. The contract condition information includes items specifying conditions for the use of copyrighted works, including a supply channel item related to the supply of the second copyrighted works, a moral rights permission item related to the first copyrighted works, a reuse permission item indicating whether creation of third copyrighted works using the second copyrighted works is permitted, and a fee item related to a method for calculating fees incurred from the supply of the second copyrighted works.

The contract management server uses the contract condition information to execute the electronic contract between the first copyright holders and the second copyright holders, and generates contract conclusion information generated according to the electronic contract. The contract conclusion information refers to information regarding the electronic contract executed based on the contract condition information.

The contract management server provides the contract condition information to the user terminals of the first and second copyright holders, and generates contract conclusion information generated according to electronic contract conditions set according to the contract condition information through the user terminals of the first and second copyright holders.

The contract conclusion unit, after setting a supply channel item for the second copyrighted works, sets a moral rights permission item corresponding to the supply channel item, sets a reuse permission item corresponding to the moral rights permission item, and then sets a fee item. The contract conclusion unit 120 thereby generates contract conclusion information including contractual supply channel information, contractual moral rights permission information, contractual reuse permission information, and contractual fee information according to the electronic contract.

After operation S1000, the copyrighted work supply server generates use status information for at least one second copyrighted work created using the first copyrighted works and provides the use status information to the contract management server upon a request from the contract management server in operation S1100.

The copyrighted work supply server stores copyrighted work matching information for the second copyrighted works. The copyrighted work matching information includes identification information of the first and second copyrighted works, and also includes matching information related to a list of second copyrighted works created using first copyrighted works and a list of first copyrighted works used in the creation of the second copyrighted works.

When a request for the use status information of the second copyrighted works created using the first copyrighted works is received from the contract management server, the copyrighted work supply server extracts second copyrighted work list information, which indicate the second copyrighted works created using the first copyrighted works, from the copyrighted work matching information. The copyrighted work supply server may extract the second copyrighted work list information corresponding to the identification information of the first copyrighted works from the copyrighted work matching information.

The copyrighted work supply server extracts use status information of the second copyrighted works corresponding to the second copyrighted work list information. For example, the copyrighted work supply server may extract actual supply channel information, actual moral rights permission information, actual reuse permission information, and actual fee information for the second copyrighted works. Thereafter, the copyrighted work supply server transmits the second copyrighted work list information and the use status information corresponding thereto to the contract management server.

After operation S1100, the contract management server generates contract monitoring information indicating whether the second copyrighted works are used in compliance with an electronic contract for copyrighted works in operation S1200.

When the second copyrighted work list information and the use status information corresponding thereto is received from the copyrighted work supply server, the contract management server extracts contract conclusion information for the second copyrighted works corresponding to the second copyrighted work list information.

Then, the contract management server may compare the contract conclusion information for the second copyrighted works (e.g., contractual supply channel information, contractual moral rights permission information, contractual reuse information, and contractual fee information) with the use status information corresponding thereto (e.g., actual supply channel information, actual moral rights permission information, actual reuse information, and actual fee information), and generate, based on a result of the comparison, contract monitoring information indicating whether the second copyrighted works created using the first copyrighted works are being used in compliance with the electronic contract.

When the contract conclusion information for the second copyrighted works and the corresponding use status information of the second copyrighted works match, the contract management server may generate use status confirmation information as contract monitoring information, indicating that the second copyrighted works are being used in compliance with the contract conditions. In addition, when the contract conclusion information for the second copyrighted works and the use status information corresponding thereto do not match, the contract management server may generate use status confirmation information as contract monitoring information, indicating that the second copyrighted works are being used abnormally (e.g., a case where the moral rights permission information does not match or where the supply channel information does not match).

After operation S1200, the contract management server transmits the contract monitoring information to a user terminal to support displaying usage analysis information on the user terminal in operation S1300. The contract monitoring information is displayed on the user terminal with the support of the contract management server.

The contract management server supports displaying contract condition information, contract conclusion information, or contract monitoring information on each first copyright holder’s user terminal. The contract management server provides a user interface to the user terminal to allow inputting a search condition for the contract condition information, the contract conclusion information, or the contract monitoring information.

When a request for electronic contract conclusion is received from a user terminal, the contract management server extracts the contract condition information for the electronic contract and supports displaying the contract condition information on the user terminal.

As the contract condition information is displayed on the user terminal, the corresponding first copyright holder or second copyright holder may set conditions of use for a corresponding first copyrighted work or the second copyrighted work according to the displayed contract condition information. Accordingly, the contract management server enables progress of the electronic contract using setting information for the electronic contract provided from the user terminal. The contract management server may allow additional conditions not yet reflected to be set, in addition to the conditions input in advance, and the contract management server may support displaying the contract conclusion information corresponding to the conclusion of the electronic contract on the user terminal. Accordingly, the contract conclusion information is displayed on the user terminal.

In addition, the contract management server supports displaying the contract monitoring information for the second copyrighted works using the first copyrighted works on the display screen of the user terminal. The contract monitoring information is displayed on the user terminal with the support of the contract management server.

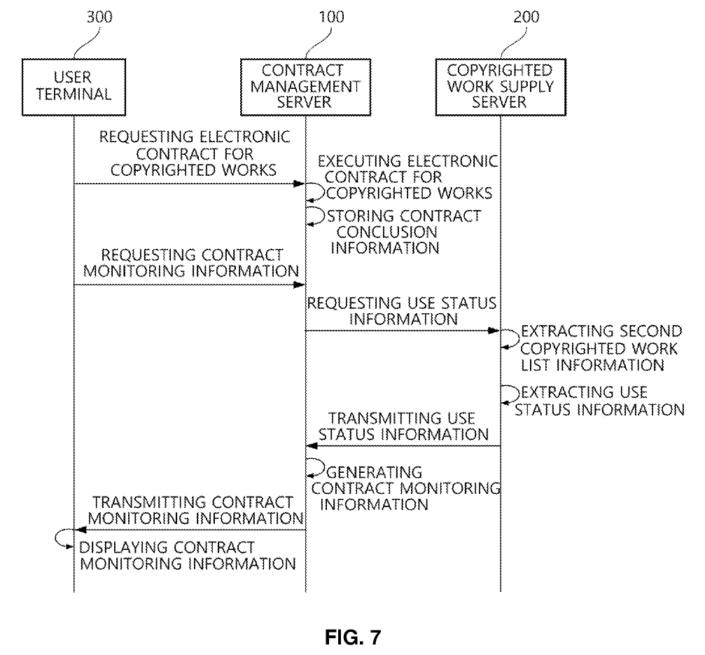

FIG. 7 is a timing diagram illustrating an overall operation process of a system and method for providing monitoring information on the use of copyrighted works for copyright holders.

First, when a request signal for an electronic contract for copyrighted works is received from a user terminal of a first or second copyright holder, the contract management server 100 uses contract condition information to execute an electronic contract for copyrighted works between the first and second copyright holders. The contract management server 100 stores contract conclusion information generated according to the electronic contract.

Thereafter, when a request signal for contract monitoring information on second copyrighted works created using first copyrighted works is received from a user terminal of a first copyright holder, the contract management server 100 requests the copyrighted work supply server 200 to provide use status information on the second copyrighted works, which is necessary to generate the contract monitoring information.

When the request for the use status information is received from the contract management server 100, the copyrighted work supply server 200 extracts second copyrighted list information for the second copyrighted works created using the first copyrighted works. Thereafter, the copyrighted work supply server 200 extracts the use status information of the second copyrighted works corresponding to the extracted second copyrighted work list information, and transmits the extracted second copyrighted work list information and the use status information corresponding thereto to the contract management server 100.

The contract management server 100 generates usage analysis information on n-th copyrighted works created using n-1 copyrighted works by using n-th copyrighted work list information and usage environment information transmitted from the copyrighted work supply server 200, and transmits the generated usage analysis information to the user terminal 300 to be displayed on a display screen of the user terminal 300.

According to the present disclosure, copyright holders of (n-1)-th copyrighted works may obtain usage analysis information on n-th copyrighted works created using the (n-1)-th copyrighted works. Accordingly, the copyright holders of the (n-1)-th copyrighted works may easily obtain information on the n-th copyrighted works in which the (n-1)-th copyrighted works are used, and may also effectively confirm whether the n-th copyrighted works created using the (n-1)-th copyrighted works are being properly used in compliance with an electronic contract for copyrighted works during a service process.

According to one aspect of the present disclosure, by providing information to copyright holders as to whether second copyrighted works are being used or serviced in accordance with the electronic contract for first copyrighted works, the copyright holders of the first copyrighted works may easily check monitoring information indicating whether the second copyrighted works created using the first copyrighted works are being properly used or serviced.

In other words, the copyright holder of each first copyrighted work may effectively check whether the second copyrighted works created using his/her work is being used properly in compliance with the electronic contract during the service process.

The effects obtainable from the present disclosure are not limited to those mentioned above, and other effects not mentioned will be apparent to a person having ordinary skill in the art from the following description.

Although the above description focuses on examples, these are merely examples and do not limit the present disclosure. Those skilled in the art will appreciate that various modifications and applications not exemplified above are possible without departing from the essential characteristics of the present disclosure. For example, each component specifically shown in the examples may be modified and implemented without departing from the scope of the present disclosure. Accordingly, the differences related to these modifications and applications should be construed as being included within the scope of the present disclosure as defined in the appended claims.

What is claimed is:

1. A system for providing monitoring information on use of copyrighted works for copyright holders, comprising:
a contract management server configured to execute an electronic contract related to use of first copyrighted works between first copyright holders of the first copyrighted works and second copyright holders of second copyrighted works created using the first copyrighted works; and
a copyrighted work supply server configured to provide an online supply service for the first copyrighted works or the second copyrighted works, generate use status information of the second copyrighted works, indicating a use status of each of at least one second copyrighted works created using the first copyrighted works, and provide the use status information to the contract management server upon a request from the contract management server,
wherein the contract management server comprises:
a contract management database configured to store contract condition information comprising a supply channel item related to a supply channel for the second copyrighted works, a moral rights permission item related to the first copyrighted works in connection with the second copyrighted works, a reuse permission item indicating whether creation of third copyrighted works using the second copyrighted works is permitted, and a fee item related to a method for calculating fees incurred from the supply of the second copyrighted works;
a contract conclusion unit configured to execute the electronic contract between the first copyright holders and the second copyright holders using the contract condition information and generate contract conclusion information according to the electronic contract; and
a monitoring information generation unit configured to compare the use status information received from the copyrighted work supply server with supply channel information, moral rights permission information, reuse permission information, and fee information included in the contract conclusion information; generate, based on a result of the comparison, contract monitoring information indicating whether the second copyrighted works are being used in compliance with the electronic contract; and transmit the contract monitoring information to a user terminal.

2. The system of claim 1, wherein the use status information comprises actual supply channel information, actual moral rights permission information, actual reuse permission information, and actual fee information for the second copyrighted works.

3. The system of claim 1, wherein the contract conclusion unit is configured, after setting the supply channel item, to set a moral rights permission item corresponding to the supply channel item, to set a reuse permission item corresponding to the moral rights permission item, and then to set a fee item, thereby generating the contract conclusion information including contractual supply channel information, contractual moral rights permission information, contractual reuse permission information, and contractual fee information according to the electronic contract.

4. The system of claim 1, wherein the contract management server further comprises a contract management interface unit configured to transmit the contract monitoring information to the user terminal and support displaying the contract monitoring information on the user terminal.

5. The system of claim 1, wherein the copyrighted work supply server comprises:
a copyrighted work database configured to store copyrighted work matching information and use status information for each of the second copyrighted works created using the first copyrighted works;
a list information extraction unit configured to, in response to receiving, from the contract management server, a request for the use status information related to the first copyrighted works, extract second copyrighted work list information for the second copyrighted works created using the first copyrighted works from the copyrighted work matching information; and
a use status information extraction unit configured to extract the use status information corresponding to the second copyrighted work list information from the copyrighted work database.

6. The system of claim 5, wherein the copyrighted work database is further configured to store, as the copyrighted work matching information, matching information related to a list of the second copyrighted works created using the first copyrighted works and a list of the first copyrighted works used in the creation of the second copyrighted works.

7. A method for providing monitoring information on use of copyrighted works for copyright holders, the method comprising:
executing, by a contract management server, an electronic contract related to use of first copyrighted works between first copyright holders of the first copyrighted works and second copyright holders of second copyrighted works created using the first copyrighted works; and
providing, by a copyrighted work supply server, use status information of the second copyrighted works indicating a use status of each of at least one second copyrighted work created using the first copyrighted works, and providing the use status information to the contract management server upon a request from the contract management server;
storing, by the contract management server, contract condition information comprising a supply channel item related to a supply channel for the second copyrighted works, a moral rights permission item related to the first copyrighted works in connection with the second copyrighted works, a reuse permission item indicating whether creation of third copyrighted works using the second copyrighted works is permitted, and a fee item related to a method for calculating fees incurred from the supply of the second copyrighted works,;
comparing, by the contract management server, the use status information received from the copyrighted work supply server with supply channel information, moral rights permission information, reuse permission information, and fee information included in contract conclusion information generated according to the electronic contract;
generating, by the contract management server based on a result of the comparing, contract monitoring information indicating whether the second copyrighted works are being used in compliance with the electronic contract; and
transmitting, by the contract management server, the generated contract monitoring information to a user terminal.

8. The method of claim 7, wherein the use status information comprises actual supply channel information, actual moral rights permission information, actual reuse permission information, and actual fee information for the second copyrighted works.

9. The method of claim 7, wherein the executing of the electronic contract comprises, after setting the supply channel item, setting a moral rights permission item corresponding to the supply channel item, subsequently setting a reuse permission item corresponding to the moral rights permission item, and then setting a fee item, thereby generating the contract conclusion information including contractual supply channel information, contractual moral rights permission information, contractual reuse permission information, and contractual fee information according to the electronic contract.

10. The method of claim 7, wherein the providing of the use status information to the contract management server comprises:
storing, by the copyrighted work supply server, copyrighted work matching information and use status information for each of the second copyrighted works created using the first copyrighted works;
extracting, from the copyrighted work matching information, second copyrighted work list information for the second copyrighted works created using the first copyrighted works, in response to a request for the use status information related to the first copyrighted works from the contract management server; and
providing the use status information corresponding to the second copyrighted work list information to the contract management server.

11. The method of claim 10, wherein the copyrighted work matching information comprises matching information related to a list of the second copyrighted works created using the first copyrighted works and a list of the first copyrighted works used in the creation of the second copyrighted works.

12. The method of claim 7, further comprising transmitting the contract monitoring information to the user terminal and supporting displaying the contract monitoring information on the user terminal.
